(19) United States
(12) Patent Application Publication
(10) Pub. No.: US 2002/0150777 A1
(43) Pub. Date: Oct. 17, 2002

(54) Electrode additives including compositions and structures formed using the same

(76) Inventors: Jeffrey A. Kerchner, Fleetwood, PA (US); Sridhar Venigalla, Macungie, PA (US)

Correspondence Address: Martha Ann Finnegan, Esq., Cabot Corporation, 157 Concord Road, Billerica, MA, 01821, US

(21) Appl. No.: 09/833,752

(22) Filed: Apr. 11, 2001

(51) Int. Cl. B32B 15/04

(52) U.S. Cl. 428/469; 428/213

(57) ABSTRACT

The present invention is directed to electrode additives, electrode compositions including the additives, capacitor structures formed using the electrode compositions, and methods of forming the electrode additives, the electrode compositions and the capacitor structures. For example, the electrode composition may be used to form electrode layers in electronic devices, such as multi-layer ceramic capacitors (MLCCs). The electrode composition is particularly well-suited for use with MLCCs that have base metal (e.g., nickel) electrodes.

### FIELD OF INVENTION

The invention relates generally to electrode materials and, more particularly, to additives to electrode materials, as well as compositions and structures formed using the electrode materials.

### BACKGROUND OF INVENTION

Many electronic devices include a dielectric material and one or more electrodes. For example, multi-layer ceramic capacitors (MLCCs) include a series of alternating dielectric and electrode layers which are stacked to form a laminate structure. Electrode layers are connected by one or more conductors which are formed on sides of the laminate structure to create a series of parallel plate capacitors.

In MLCC devices, it is typically desirable to have a high capacitance. The capacitance of an MLCC may be increased by increasing the number of alternating layers (i.e., the number of parallel plate capacitors). Because the thickness of an MLCC is generally fixed, the number of layers in an MLCC can be increased by decreasing the thickness of the layers. As a result, MLCC manufacturers have sought to decrease layer thickness to obtain MLCCs having a high capacitance.

Electrode materials for MLCCs, and other devices, generally include a metal which may be mixed with other species, such as a binder. The metal is present in amounts so that the electrode is sufficiently conductive. In some MLCCs, the electrode material includes a noble metal such as palladium (Pd) or a palladium/silver (Pd/Ag) alloy. In other cases, the electrode material includes a base metal such as nickel (Ni) or copper (Cu). Nickel has the advantage of being less expensive than noble metals. Thus, lower material costs may be achieved by using nickel electrodes rather than noble metal electrodes.

Electrode layers, particularly base metal electrodes such as nickel electrodes, may not strongly adhere to dielectric layers during processing. In particular, during firing (i.e., sintering) of the MLCC, the coverage of electrode layers on respective dielectric layers may become non-uniform as a result of insufficient adherence. For example, an electrode layer may “ball up” to form thick regions and thin regions on a dielectric layer, as well as voids within the electrode layer. The voids create regions on a dielectric layer that have no electrode layer formed thereupon and, thus, may contact the next dielectric layer in the MLCC laminate structure. Such regions can impair device performance and reliability and, therefore, can reduce manufacturing yields. To address this problem, manufacturers have used relatively thick electrodes which can reduce the number of regions of voids within electrode layers. However, increasing electrode layer thickness for a given MLCC thickness reduces the number of electrode and dielectric layers in the MLCC which lowers its capacitance.

Accordingly, a need exists for techniques that improve the adherence of electrodes, particularly base metal electrodes, to dielectric layers in electronic devices, such as MLCCs.

### SUMMARY OF INVENTION

The present invention is directed to electrode additives, electrode compositions including the additives, capacitor structures formed using the electrode compositions, and methods of forming the electrode additives, the electrode compositions and the capacitor structures.

In one aspect, the invention provides an electrode composition. The electrode composition includes a base metal, and ceramic particles comprising a component capable of reacting with the base metal to form a bonding material.

In another aspect, the invention provides an electrode composition. The electrode composition includes a base metal, and ceramic particles comprising a component that increases wettability of the electrode composition on a dielectric layer.

In another aspect, the invention provides an electrode composition. The electrode composition includes a base metal, ceramic particles, and particles comprising a component capable of reacting with the base metal to form a bonding material.

In another aspect, the invention provides an electrode additive composition including ceramic particles having a coating comprising an aluminum compound. The aluminum compound is the major compound in the coating.

In another aspect, the invention provides a capacitor structure. The capacitor structure includes at least one dielectric layer, and at least one electrode layer formed on the dielectric layer. The electrode layer includes a base metal, a ceramic, and a bonding material formed at the interface between the base metal and the ceramic.

In another aspect, the invention provides a capacitor structure. The capacitor structure includes at least one dielectric layer, and a base metal electrode layer formed on the dielectric layer. The base metal electrode layer has an average thickness of less than about 1.0 micron.

In another aspect, the invention provides method of forming an electrode composition. The method includes mixing base metal particles and ceramic particles comprising a component to form the electrode composition. The component is capable of reacting with the base metal to form a bonding material.

In another aspect, the invention provides a method of forming an electrode composition. The method includes mixing base metal particles and ceramic particles comprising a component to form the electrode composition. The component increases wettability of the electrode composition on a dielectric layer.

In another aspect, the invention provides a method of forming an electrode additive composition. The method includes forming a coating on ceramic particles. The coating comprises an aluminum compound. The aluminum compound is the major compound in the coating.

In another aspect, the invention provides a method of forming a capacitor structure. The method includes forming at least one dielectric layer, and forming at least one electrode layer on the dielectric layer. The electrode layer includes a base metal, a ceramic, and a bonding material formed at the interface between the base metal and the ceramic.

In another aspect, the invention provides a method of forming a capacitor structure. The method includes forming at least one dielectric layer, and forming a base metal electrode layer on the dielectric layer. The base metal electrode layer has an average thickness of less than about 1.0 micron.

Other novel features and aspects of the invention will become apparent from the following detailed description of the invention when considered in conjunction with the accompanying figures, and from the claims.

### BRIEF DESCRIPTION OF THE DRAWINGS

FIG. 1 schematically shows a multi-layer ceramic capacitor according to one embodiment of the present invention.

### DETAILED DESCRIPTION

The present invention provides an additive which may be incorporated in an electrode composition. The electrode composition may be used to form electrode layers in electronic devices, such as multi-layer ceramic capacitors (MLCCs). The electrode composition is particularly well-suited for use with MLCCs that have base metal (e.g., nickel) electrodes. The electrode additive includes ceramic particles which can comprise a component. The component, for example, may be formed as a coating on the ceramic particles. As described further below, the interaction between the component and a metal in the electrode composition increases the wettability of the electrode composition on a dielectric layer during processing (e.g., sintering). The increased wettability improves the adherence of electrode layers to dielectric layers during processing (e.g., sintering). The increased adherence can increase the contact area between electrode layers and adjacent dielectric layers by reducing (or eliminating) the problem of forming non-uniform electrode layers and voids within the electrode layer. Thus, devices including very thin and/or uniform electrode layers may be produced.

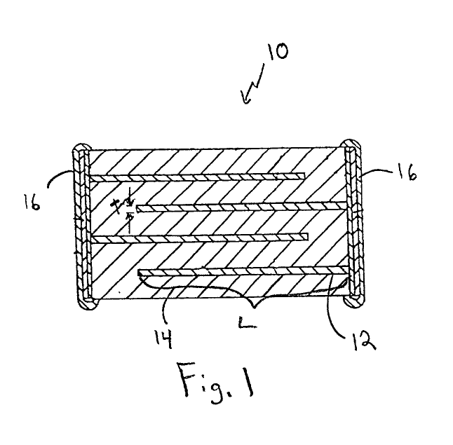

FIG. 1 schematically shows a multi-layer ceramic capacitor 10 according to one embodiment of the present invention. Capacitor 10 includes a series of alternating electrode layers 12 and dielectric layers 14. Conducting layers 16 are formed on both sides of capacitor 10 to electrically connect alternating electrode layers 12. As described further below, electrode layers 12 have a composition that includes the electrode additive and, preferably, a base metal.

In some preferred embodiments, electrode layer 12 is very thin. For example, electrode layer 12 may have an average thickness (t) of less than about 1.0 micron. When even thinner electrode layers are desired, electrode layer 12 may have an average thickness of less than about 0.5 micron. As used herein the term “average thickness” refers to the electrode layer thickness averaged over the entire electrode layer. Any voids that may exist in the electrode layer are not factored into the average thickness determination. When electrode layers 12 are very thin, it is possible for capacitor 10 to include a large number of electrode layers which provides the capacitor with a high capacitance.

In some preferred embodiments, capacitor 10 includes electrode layers 12 that uniformly cover respective dielectric layers 14 and have a high contact area with respective dielectric layers. The high contact area results from the strong adherence between electrode layers 12 and dielectric layers 14 during processing which limits (or prevents) the formation of “balled up” regions and voids within electrode layer 12 that otherwise reduce the contact area between electrode layers and dielectric layers. Contact area may be quantified by measuring the percentage of the length (L) of an electrode layer that contacts the adjacent dielectric layer in a representative cross-section of a device (e.g., a capacitor). The measurement may be made using an SEM (scanning electron microscope) or optical microscope. Any voids in an electrode layer do not contribute to the contact area.

In some cases, a majority (or even all) of electrode layers 12 in capacitor 10 contact adjacent dielectric layers 14 over greater than 50% of a length of the respective electrode layer. In applications where greater contact areas are desired, a majority (or even all) of electrode layers 12 in capacitor 10 contact adjacent dielectric layers 14 over greater than 70% of a length of the respective electrode layer. Such high contact areas are obtainable even when electrode layer is very thin (i.e., less than 1.0 micron, or less than 0.5 micron).

It should be understood that capacitor 10 of FIG. 1 is shown with exaggerated dimensions to better illustrate features of the invention. In practice, multi-layer ceramic capacitors generally have several hundred electrode and dielectric layers. It should also be understood that not every embodiment of the invention includes very thin electrode layers or uniform electrode layers.

The ceramic particles of the electrode additive in electrode layer 12 are typically dielectric materials. In certain preferred embodiments, the ceramic particles have a barium titanate-based composition. As used herein, “barium titanate-based compositions” refer to barium titanate, solid solutions thereof, or other oxides based on barium and titanium having the general structure ABO₃, where A represents one or more divalent metals such as barium, calcium, lead, strontium, magnesium and zinc and B represents one or more tetravalent metals such as titanium, tin, zirconium, and hafnium. One type of barium titanate-based composition has the structure Ba₍₁₋ₓ₎AₓTi_{(1-y)}B_{y}O₃, where x and y can be in the range of 0 to 1, where A represents one or more divalent metal other than barium such as lead, calcium, strontium, magnesium and zinc and B represents one or more tetravalent metals other than titanium such as tin, zirconium and hafnium. Where the divalent or tetravalent metals are present as impurities, the value of x and y may be small, for example less than 0.1. In other cases, the divalent or tetravalent metals may be introduced at higher levels to provide a significantly identifiable compound such as barium-calcium titanate, barium-strontium titanate, barium titanate-zirconate, and the like. In still other cases, where x or y is 1.0, barium or titanium may be completely replaced by the alternative metal of appropriate valence to provide a compound such as lead titanate or barium zirconate. In other cases, the compound may have multiple partial substitutions of barium or titanium. An example of such a multiple partial substituted composition is represented by the structural formula Ba_{(1-x-x′-x″)} PbₓCa_{x′}Sr_{x″}O.Ti_{(1-y-y′-y″)} Sn_{y}Zr_{y′}Hf_{y″}O₂, where x, x′, x″, y, y′, and y″ are each greater than or equal to 0. In many cases, the barium titanate-based composition will have a perovskite crystal structure, though in other cases it may not.

It should be understood that the ceramic particles of the electrode additive may have other compositions, such as aluminum oxide (Al₂O₃) particles, as described further below.

The ceramic particles in the electrode additive may have a variety of different particle characteristics. The ceramic particles typically have an average primary particle size of less than about 1.0 micron; in some cases, the average primary particle size may be less than about 0.5 micron; most preferably, the average primary particle size is less than about 0.1 micron. The particular particle size depends in part on the requirements of the application such as the desired layer thickness. The average primary particle size may be determined by conventional imaging from scanning electron microscopy (SEM) analysis or transmission electron microscopy (TEM) analysis.

In some embodiments, the ceramic particles may agglomerate and/or aggregate to form aggregates and/or agglomerates of aggregates. At times, it may be preferable to use ceramic particles that are not strongly agglomerated and/or aggregated such that the particles may be relatively easily dispersed, for example, by high shear mixing. Suitable barium titanate-based particles are described in commonly-owned, co-pending U.S. patent application Ser. No. 08/923,680, filed Sep. 4, 1997, which is incorporated herein by reference in its entirety.

The ceramic particles of the electrode additive may also have a variety of shapes which may depend, in part, upon the process used to produce the particles. For example, milled ceramic particles generally have an irregular, non-equiaxed shape. In other cases, the ceramic particles may be equiaxed and/or substantially spherical. Substantially spherical particles may be preferred in certain cases, in part, because the substantially spherical shape allows a large number of particles to be packed into a given volume.

The ceramic particles of the electrode additive may be produced according to any technique known in the art including hydrothermal processes, solid-state reaction processes, sol-gel processes, as well as precipitation and subsequent calcination processes, such as oxalate-based processes. In some embodiments, particularly when substantially spherical particles and/or barium titanate-based particles are desired, it may be preferable to produce the particles using a hydrothermal process. Suitable hydrothermal processes for forming barium titanate-based particles have been described, for example, in commonly-owned U.S. Pat. Nos. 4,829,033, 4,832,939, and 4,863,883, which are incorporated herein by reference in their entireties.

As described above, the ceramic particles of the electrode additive composition may comprise a component. In certain preferred embodiments, the ceramic particles are coated with the component. For example, barium titanate-based particles may be coated with the component to form the electrode additive composition. In other embodiments, the ceramic particles themselves may be formed of the component and, thus, form the electrode additive composition. As described further below, aluminum oxide may function as the component and, thus, aluminum oxide particles (without coatings) may form the electrode additive composition. In some cases, the electrode additive composition may include aluminum oxide particles and non-coated barium titanate-based particles. In some cases, the electrode additive composition may comprise ceramic particles (e.g., barium titanate-based particles) and other types of particles which comprise the component (e.g., aluminum oxide).

In certain preferred embodiments, the component is capable of reacting with a metal (e.g., a base metal) in the electrode composition. For example, the component may react with the metal to form a binding material at the interface of the ceramic particle and the metal. In some embodiments, the binding material is a solid solution of the metal and the component. The reaction between the ceramic particle and the metal (e.g., base metal) reduces the surface energy of the electrode composition which increases the wettability of the electrode composition on a dielectric layer during firing. In some embodiments, the component may not react with a metal, but still acts to increase the wettability of the electrode composition on a dielectric layer.

The component generally includes a metallic species and often is a metal compound such as an oxide, a hydroxide, or a hydrous oxide. However, in some cases, the component may be a pure metal. When the component is in particulate form, it is often a metal oxide. When the component is coated onto particles, it is often a metal hydroxide, or a metal hydrous oxide (both of which are converted into oxides during sintering). Suitable metal compounds include compounds of aluminum, selenium, antimony, sulfur, chromium, phosphorous, silicon, and boron. It should be understood, however, that compounds of other metals may also be suitable to form the component. Aluminum compounds, such as aluminum hydroxide (Al(OH)₃) coatings or aluminum oxide particles, may be particularly preferred in some cases, for example, when the electrode composition includes nickel. The aluminum compound may react with the nickel to form an aluminum-nickel solid solution (e.g., a nickel-aluminum oxide (NiAl₂O₄)) as the binding material. When the component is a pure metal, aluminum may be preferred.

When the component is provided as a coating, the coating may be formed of a single compound, such as a single aluminum compound (i.e., the coating is formed only of the aluminum compound). In other cases, the coating may include multiple compounds. In multiple compound embodiments, it may be preferable for the component to be the major compound in the coating (i.e., the compound having the highest weight percentage in the coating). The major compound, for example, may be an aluminum compound. In some cases, the weight percentage of the aluminum compound in the coating is greater than 50 percent of the total weight of the coating; in other cases, greater than 75 percent of the total weight of the coating; and, in other cases, greater than 95 percent of the total weight of the coating. In multiple compound embodiments, each compound may be coated in successive layers with each layer having its own composition. When the particles include successive coating layers, it is preferable for the outermost layer to be the major compound.

The ceramic particles are generally coated with the component in an amounts at least sufficient to obtain the desired wettability of the electrode composition. Typical thicknesses of the coating are in the range of between about 0.1 nm and about 10.0 nm. Other coating thicknesses may be also be effective. In certain embodiments, it may be desirable to produce a coating over the entire particle surface. In other embodiments, the coating may cover only a portion of the particle surface. A minority amount of the ceramic particles in the additive composition may not be coated at all.

Any suitable coating technique known in the art may be used to form the coatings on the ceramic particles of the electrode additive. In certain embodiments, a precipitation technique may be preferred. In one exemplary precipitation technique, the ceramic particles may be dispersed in a fluid medium (e.g., an aqueous medium) to form a slurry prior to the coating process. The ceramic particles, for example, are present in amounts between about 5 and about 50 weight percent based on the total weight of the slurry. In many cases, the pH of the slurry is maintained at greater than 7 to aid in the precipitation. The coating process involves adding suitable solutions containing ionic species which are capable of reacting to form the component. The reaction causes the component to precipitate from the slurry as a coating on the ceramic particle surfaces because the energy required to nucleate the compound is minimized at particle surfaces. When forming an aluminum hydroxide coating, for example, a suitable solution containing aluminum ions is added to an aqueous slurry along with ammonia to precipitate aluminum hydroxide on the particles. After the coating process, the coated ceramic particles may be dried to form the electrode additive. In other cases, the coated ceramic particles may be de-watered (but maintained wet) and mixed with the other constituents to form the electrode composition.

The electrode additive is added to the electrode composition. As described above, preferably, the electrode composition includes a base metal. The base metal may be, for example, nickel, copper, or alloys thereof. Nickel is the preferred material for the electrode in many embodiments. The base metal is generally in particulate form when mixed with the coated ceramic particles. The base metal particles generally have a particle size similar to that of the coated ceramic particles. Though in some cases, the base metal particles may be smaller or larger than the coated ceramic particles.

The electrode composition also generally includes a binder. The binder typically is a polymeric material which holds the electrode together to form a cohesive layer. Suitable binders are known in the art.

The electrode composition generally includes between about 1% and 50% by volume of the electrode additive; in some embodiments, between about 10% and 30% by volume of the electrode additive. The electrode composition including the electrode additive, base metal, and binder may be dispersed in a liquid carrier to form an electrode paste. The liquid carrier can facilitate spreading the electrode composition to form electrode layer 12 (FIG. 1). In some cases, the liquid carrier may be a solvent in which the binder is dissolved. Generally, the binder and the liquid carrier are burned off during the firing process.

Referring again to FIG. 1, dielectric layer 14 may be composed of any dielectric material known in the art. Dielectric layer 14 is typically formed from a particulate dielectric composition. The dielectric particles may have any of the compositions, particle sizes, and particle shapes described above in connection with the ceramic particles used to form the electrode additive. In certain preferred embodiments, the dielectric material includes a barium titanate-based particulate composition as defined above. In some preferred embodiments, the dielectric particles are substantially the same as the ceramic particles (prior to coating) of the electrode additive. In some embodiments, particularly when barium titanate-based compositions are used, the ceramic particles and dielectric particles may be made in the same process and then separated. Hydrothermal processes may be particularly preferred to form substantially spherical dielectric particles. In some cases, it may be preferable to heat treat the dielectric particles prior to formation of the dielectric layer. Heat treatment processes can increase the average particle size and are described, for example, in commonly-owned, co-pending U.S. patent application Ser. No. 09/689,093, entitled “Production of Dielectric Particles,” filed on Oct. 12, 2000, which is incorporated herein by reference in its entirety.

In some embodiments, one or more dopant materials may be added to the dielectric composition prior to forming dielectric layer 14 to enhance electrical properties. Any dopant known in the art may be added to the composition. Dopants are often metal compounds, such as oxides or hydroxides. Suitable dopant metals may include lithium, magnesium, molybdenum, tungsten, chromium, scandium, zirconium, vanadium, niobium, tantalum, manganese, cobalt, nickel, zinc, boron, silicon, antimony, tin, yttrium, lanthanum, lead, bismuth or a Lanthanide element. The dopants may be added in particulate form and mixed into the dielectric particles to promote the formation of a homogeneous mixture. In other cases, one or more dopant layers may be coated onto the surfaces of the dielectric particles. The dopant layers may be coated, for example, in a precipitation process similar to that described in connection with the coated ceramic particles. The dopant layers may be coated successively to form a series of chemically distinct layers. In some embodiments, certain types of dopants may be added in particulate form, while other types of dopants may be coated onto the surfaces of the dielectric particles.

In some embodiments, the A/B ratio of the dielectric composition may be adjusted prior to formation of dielectric layer 14. As used herein, A/B ratio is defined as the ratio of divalent metals (e.g., alkaline earth metals such as Ba, Ca, Sr, etc.) to tetravalent metals (Ti, Zr, Sn, etc.) in the overall dielectric composition. In some cases, the A/B ratio is adjusted to a value greater than 1.0. Barium titanate-based compositions having A/B ratios greater than 1.0 (e.g., A/B ratio of between about 1.05 and about 1.15) may be particularly desirable in certain MLCCs applications to the improve compatibility of the composition with base metal electrodes.

The A/B ratio may be adjusted according to any technique known in the art. In some embodiments, the A/B ratio may be increased by adding an insoluble divalent metal (e.g., Ba) compound in particulate form to the composition. In other embodiments, the insoluble divalent metal compound (e.g., BaCO₃) may be formed, for example, in a precipitation reaction between an insolubilizing agent and a divalent metal. The insoluble divalent metal compound may be precipitated in particulate form or as a coating on surfaces of the dielectric particles. The coating may be provided similarly, and in the same step, as the dopant coatings described above. In some embodiments, it may be preferable to deposit the divalent metal compound coating on the particle surfaces as the first coating layer subsequent to depositing the dopant coating layers.

In some embodiments, the A/B ratio may be adjusted by adding a sintering aid the composition which includes A or B elements. For example, the sintering aid may be a single component silicate, such as barium silicate (BaSiO₃), or a multi-component silicate, such as barium-calcium silicate (BaₓCa₁₋ₓSiO₃) as described in commonly-owned, co-pending U.S. patent application Ser. No. 09/640,498, entitled “Silicate-Based Sintering Aid and Method,” filed on Aug. 16, 2000, which is incorporated herein by reference in its entirety.

It should be understood that the dielectric composition used to form dielectric layer 14 may include other species known in the art such as binders, dispersing agents, and the like.

Any technique known in the art may be used to form multi-layer ceramic capacitor 10 (FIG. 1). One exemplary technique is described herein. The dielectric composition and the electrode composition, including the electrode additive, are prepared as described above. The dielectric composition is dispersed to form a slurry to which dispersants and binders are added to form a castable slip. The slip is cast to form a “green” layer of dielectric material. An electrode paste including the electrode composition and a liquid carrier is spread on the green layer. Additional green layers and electrode layers are similarly prepared and stacked to form a laminate of alternating green ceramic dielectric and electrode layers. The stacks are diced into MLCC-sized cubes. The cubes are heated to burn off organic materials, such as binders and dispersants. Then, the cubes are fired to sinter the particles of the dielectric material to form dense dielectric layers. During sintering, a reaction may occur between the metal in the electrode composition and the component of electrode additive to form a binding material which increases the wettability of the electrode composition on the surface of the dielectric material. The wetting results in strong adhesion between the dielectric composition and the electrode composition during sintering which limits or prevents separation therebetween. Referring again to FIG. 1, after sintering, the multi-layer ceramic capacitor 10 includes a series of alternating electrode layers 12 and dielectric layers 14.

It should be understood that although particular embodiments and examples of the invention have been described in detail for purposes of illustration, various changes and modifications may be made without departing from the scope and spirit of the invention. Accordingly, the invention is not to be limited except as by the appended claims.

What is claimed is:

1. An electrode composition comprising:
a base metal; and
ceramic particles comprising a component capable of reacting with the base metal to form a bonding material.

2. The electrode composition of claim 1, wherein the ceramic particles include a coating, the coating comprising the component.

3. The electrode composition of claim 1, wherein the component comprises a metal.

4. The electrode composition of claim 1, wherein the component comprises a metal oxide, a metal hydroxide, or a metal hydrous oxide.

5. The electrode composition of claim 1, wherein the component comprises aluminum.

6. The electrode composition of claim 5, wherein the component comprises aluminum hydroxide.

7. The electrode composition of claim 1, wherein the component comprises selenium.

8. The electrode composition of claim 1, wherein the component comprises antimony.

9. The electrode composition of claim 1, wherein the component comprises sulfur.

10. The electrode composition of claim 1, wherein the component comprises chromium.

11. The electrode composition of claim 1, wherein the component comprises phosphorous.

12. The electrode composition of claim 1, wherein the component comprises silicon.

13. The electrode composition of claim 1, wherein the component comprises boron.

14. The electrode composition of claim 1, wherein the bonding material comprises a solid solution.

15. The electrode composition of claim 1, wherein the bonding material comprises NiAl₂O₄.

16. The electrode composition of claim 1, wherein the base metal comprises nickel.

17. The electrode composition of claim 1, wherein the ceramic particles comprise barium titanate-based particles.

18. The electrode composition of claim 1, wherein the ceramic particles comprise aluminum oxide particles.

19. The electrode composition of claim 1, wherein the ceramic particles are substantially spherical.

20. An electrode composition comprising:
a base metal;
ceramic particles; and
particles comprising a component capable of reacting with the base metal to form a bonding material.

21. An electrode composition comprising:
a base metal; and
ceramic particles comprising a component that increases wettability of the electrode composition on a dielectric layer.

22. The electrode composition of claim 21, wherein the component is capable of reacting with the base metal to form a bonding material.

23. An electrode additive composition including ceramic particles having a coating comprising an aluminum compound, the aluminum compound being the major compound in the coating.

24. The electrode additive composition of claim 23, wherein the ceramic particles comprise barium titanate-based particles.

25. The electrode additive composition of claim 23, wherein the ceramic particles have an average particle size of less than 0.5 micron.

26. The electrode additive composition of claim 23, wherein the ceramic particles are substantially spherical.

27. The electrode additive composition of claim 23, wherein the coating comprises aluminum hydroxide.

28. The electrode additive composition of claim 23, wherein the weight percentage of the aluminum compound in the coating is greater than 50 percent of the total weight of the coating.

29. The electrode additive composition of claim 23, wherein the coating is the aluminum compound.

30. A capacitor structure comprising:
at least one dielectric layer; and
at least one electrode layer formed on the dielectric layer, the electrode layer including a base metal, a ceramic, and a bonding material formed at the interface between the base metal and the ceramic.

31. The capacitor structure of claim 30, wherein the bonding material comprises a solid solution.

32. The capacitor structure of claim 30, wherein the bonding material comprises the base metal.

33. The capacitor structure of claim 30, wherein the bonding material comprises aluminum.

34. The capacitor structure of claim 30, wherein the bonding material comprises NiAl₂O₄.

35. The capacitor structure of claim 30, wherein the bonding material comprises a layer surrounding, at least in part, the ceramic.

36. The capacitor structure of claim 30, wherein the base metal comprises nickel.

37. The capacitor structure of claim 30, wherein the dielectric layer comprises a barium titanate-based composition.

38. The capacitor structure of claim 30, wherein the ceramic comprises a barium titanate-based composition.

39. The capacitor structure of claim 30, wherein the ceramic comprises aluminum oxide.

40. The capacitor structure of claim 30, wherein the ceramic and the dielectric layer comprise the same composition.

41. The capacitor structure of claim 30, wherein the electrode layer has a thickness of less than about 1.0 micron.

42. The capacitor structure of claim 30, wherein the electrode layer has a thickness of less than about 0.5 micron.

43. The capacitor structure of claim 30, further comprising a series of dielectric layers and electrode layers stacked to form a multi-layer ceramic capacitor.

44. A capacitor structure comprising:
at least one dielectric layer; and
a base metal electrode layer formed on the dielectric layer, the base metal electrode layer having an average thickness of less than about 1.0 micron.

45. The capacitor structure of claim 44, wherein the base metal electrode layer has an average thickness of less than about 0.5 micron.

46. The capacitor structure of claim 44, wherein the base metal electrode layer comprises a base metal, a ceramic, and a bonding material formed at the interface between the base metal and the ceramic.

47. The capacitor structure of claim 44, wherein the capacitor includes a plurality of dielectric layers and base metal electrode layers, the base metal electrode layers having a length parallel to adjacent dielectric layers, wherein a majority of the electrode layers contact adjacent dielectric layers over greater than 50% of the electrode layer length.

48. The capacitor structure of claim 47, wherein a majority of the electrode layers contact adjacent dielectric layers over greater than 70% of the electrode layer length.

49. A method of forming an electrode composition comprising:
mixing base metal particles and ceramic particles comprising a component to form the electrode composition,
wherein the component is capable of reacting with the base metal to form a bonding material.

50. The method of claim 49, further comprising coating the ceramic particles prior to mixing with the base metal particles.

51. The method of claim 49, wherein the component comprises a metal oxide, a metal hydroxide, or a metal hydrous oxide.

52. The method of claim 49, wherein the component comprises aluminum.

53. The method of claim 49, wherein the bonding material comprises NiAl₂O₄.

54. The method of claim 49, wherein the base metal comprises nickel.

55. The method of claim 49, wherein the ceramic particles comprise barium titanate-based particles.

56. A method of forming an electrode composition comprising:
mixing base metal particles and ceramic particles comprising a component to form the electrode composition, the component increasing the wettability of the electrode composition on a dielectric layer.

57. The method of claim 56, wherein the component is capable of reacting with the base metal to form a bonding material.

58. A method of forming an electrode additive composition comprising:
forming a coating on ceramic particles, the coating comprising an aluminum compound, wherein the aluminum compound is the major compound in the coating.

59. The method of claim 58, wherein the coating comprises aluminum hydroxide.

60. The method of claim 58, wherein the weight percentage of the aluminum compound in the coating is greater than 50 percent of the total weight of the coating.

61. The method of claim 58, wherein the coating is the aluminum compound.

62. A method of forming a capacitor structure comprising:
forming at least one dielectric layer; and
forming at least one electrode layer on the dielectric layer, the electrode layer including a base metal, a ceramic, and a bonding material formed at the interface between the base metal and the ceramic.

63. The method of claim 62, wherein the bonding material comprises the base metal.

64. The method of claim 62, wherein the bonding material comprises aluminum.

65. The method of claim 62, wherein the bonding material comprises NiAl₂O₄.

66. The method of claim 62, wherein the base metal comprises nickel.

67. The method of claim 60, wherein the ceramic and the dielectric layer comprise the same composition.

68. The method of claim 60, further comprising stacking a series of dielectric layers and electrode layers to form a multi-layer ceramic capacitor.

69. A method of forming a capacitor structure comprising:
forming at least one dielectric layer; and
forming a base metal electrode layer on the dielectric layer, the base metal electrode layer having an average thickness of less than about 1.0 micron.

70. The method of claim 69, wherein the base metal electrode layer has an average thickness of less than about 0.5 micron.

71. The method of claim 69, wherein the base metal electrode layer comprises a base metal, a ceramic, and a bonding material formed at the interface between the base metal and the ceramic.
